(19) United States
(12) Patent Application Publication
(10) Pub. No.: US 2010/0117531 A1
(43) Pub. Date: May 13, 2010

(54) ORGANIC LIGHT EMITTING DEVICE AND MANUFACTURING METHOD THEREOF

(75) Inventors: Seung-Kyu Park, Hwaseong-si (KR); Joon-Hoo Choi, Seoul (KR); Kyu-Sik Cho, Suwon-si (KR); Byoung-Kwon Choo, Hwaseong-si (KR); Yong-Hwan Park, Seoul (KR); Sang-Ho Moon, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/417,841

(22) Filed: Apr. 3, 2009

(30) Foreign Application Priority Data
Nov. 13, 2008 (KR) 10-2008-0112913

(51) Int. Cl. H01J 1/62; H01J 9/00

(52) U.S. Cl. 313/512; 445/58

(57) ABSTRACT

The present invention relates to an organic light emitting device and a manufacturing method thereof. An organic light emitting device includes a first substrate, a thin film structure disposed on the first substrate, a second substrate comprising an inner surface and an outer surface, a first sealing member disposed between the first substrate and the second substrate, the first sealing member comprising an inner surface and an outer surface, and a second sealing member disposed on the outer surface of the second substrate.

### CROSS REFERENCE TO RELATED APPLICATION

This application claims priority from and the benefit of Korean Patent Application No. 10-2008-0112913, filed on Nov. 13, 2008, which is hereby incorporated by reference for all purposes as if fully set forth herein.

### BACKGROUND OF THE INVENTION

1. Field of the Invention

The present invention relates to an organic light emitting device (“OLED”) and a manufacturing method thereof.

2. Discussion of the Background

An OLED is a self-emissive display device using a light emitting layer.

If a light emitting layer of the OLED is exposed to moisture and/or oxides, however, the light emitting characteristics thereof may deteriorate. Accordingly, after forming a thin film structure including the light emitting layer and a thin film transistor (“TFT”), the thin film structure is usually covered by an encapsulation layer such as a metal enclosure or a glass substrate to close and seal the space to reduce exposure to moisture and/or oxides. A passivation layer may alternatively be used to protect the thin film structure.

However, the conventional encapsulation layer and the method for encapsulating the light emitting layer may not effectively keep moisture and oxygen out of the light emitting layer, and also may be difficult to apply to a larger substrate.

A method has been proposed in which a sealant is directly formed on the thin film structure, or the thin film structure is covered with the passivation layer and sealed by the sealant. However, the sealant that has been used may not effectively prevent moisture penetration, and moisture penetration may occur through a defective portion of the passivation layer if the passivation layer has a poor uniformity.

### SUMMARY OF THE INVENTION

The present invention provides an OLED with an enhanced seal, and a simplified sealing method thereof.

Additional features of the invention will be set forth in the description which follows, and in part will be apparent from the description, or may be learned by practice of the invention.

The present invention discloses an OLED that includes: a first substrate, a thin film structure disposed on the first substrate, a second substrate comprising an inner surface and an outer surface, a first sealing member disposed between the first substrate and the second substrate, the first sealing member comprising an inner surface and an outer surface, and a second sealing member disposed on the outer surface of the second substrate.

The present invention also discloses a method for manufacturing an OLED that includes forming a thin film structure on a first substrate, arranging a second substrate to face the first substrate, the second substrate comprising an inner surface and an outer surface, forming a first sealing member between the first substrate and the second substrate, the first sealing member comprising an inner surface and an outer surface, and forming a second sealing member on the outer surface of the second substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of an OLED according to an exemplary embodiment of the present invention.

FIG. 2A is a cross-sectional view of the OLED shown in FIG. 1, taken along line I-I′ according to an exemplary embodiment of the present invention.

FIG. 2B is a cross-sectional view of the OLED shown in FIG. 1, taken along line I-I′ according to an exemplary embodiment of the present invention.

FIG. 3A, FIG. 3B, FIG. 3C, FIG. 3D, FIG. 3E, and FIG. 3F are cross-sectional views showing a method for manufacturing an OLED according to an exemplary embodiment of the present invention.

FIG. 4 is a plan view of an OLED according to another exemplary embodiment of the present invention.

FIG. 5 is a cross-sectional view of the OLED shown in FIG. 4, taken along line I-I′.

FIG. 6A, FIG. 6B, and FIG. 6C are cross-sectional views showing a method for manufacturing an OLED according to an exemplary embodiment of the present invention.

FIG. 7 is a plan view of an OLED according to another exemplary embodiment of the present invention.

FIG. 8 is a cross-sectional view of the OLED shown in FIG. 7, taken along line I-I′.

FIG. 9A, FIG. 9B, FIG. 9C, and FIG. 9D are cross-sectional views of showing a method for manufacturing an OLED according to an exemplary embodiment of the present invention.

FIG. 10 is a cross-sectional view of a thin film structure according to an exemplary embodiment of the present invention.

FIG. 11 is a cross-sectional view of a thin film structure according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

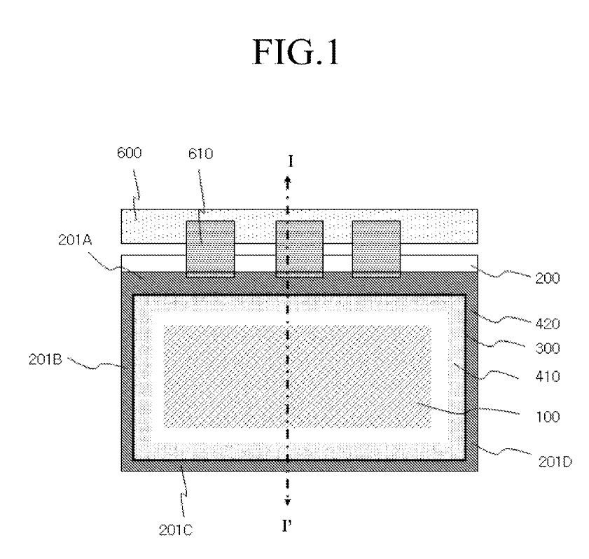

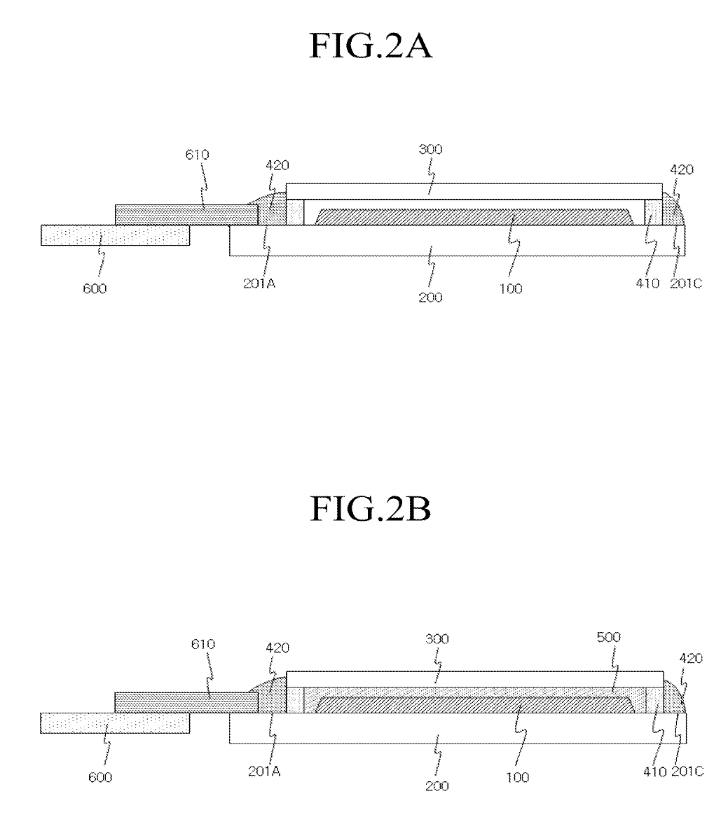

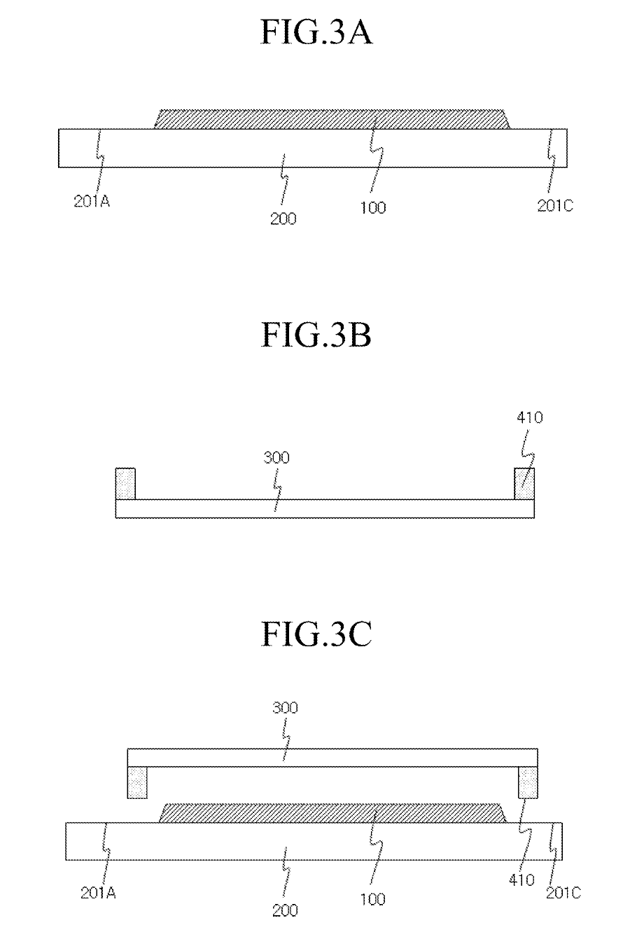

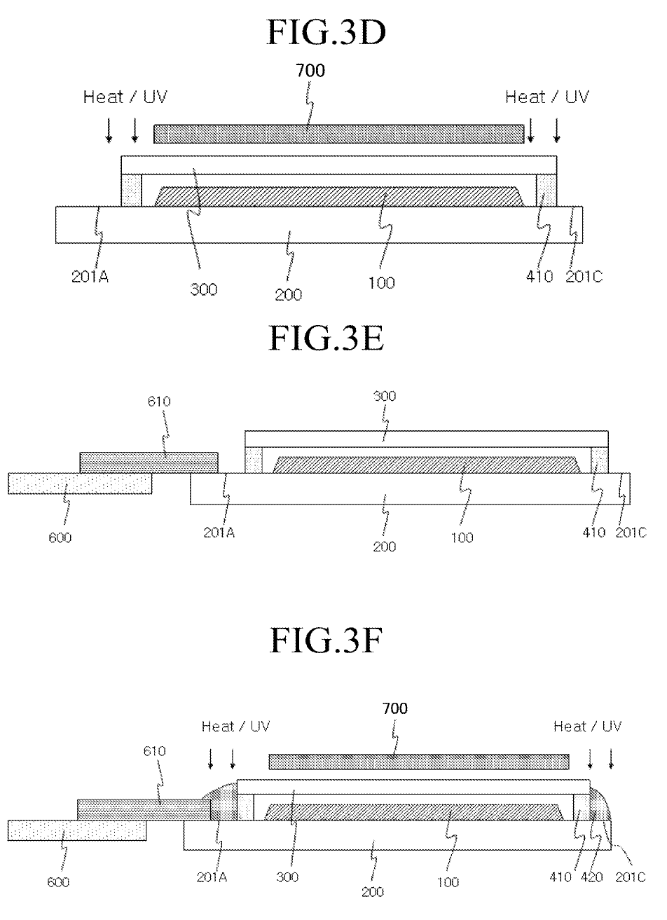

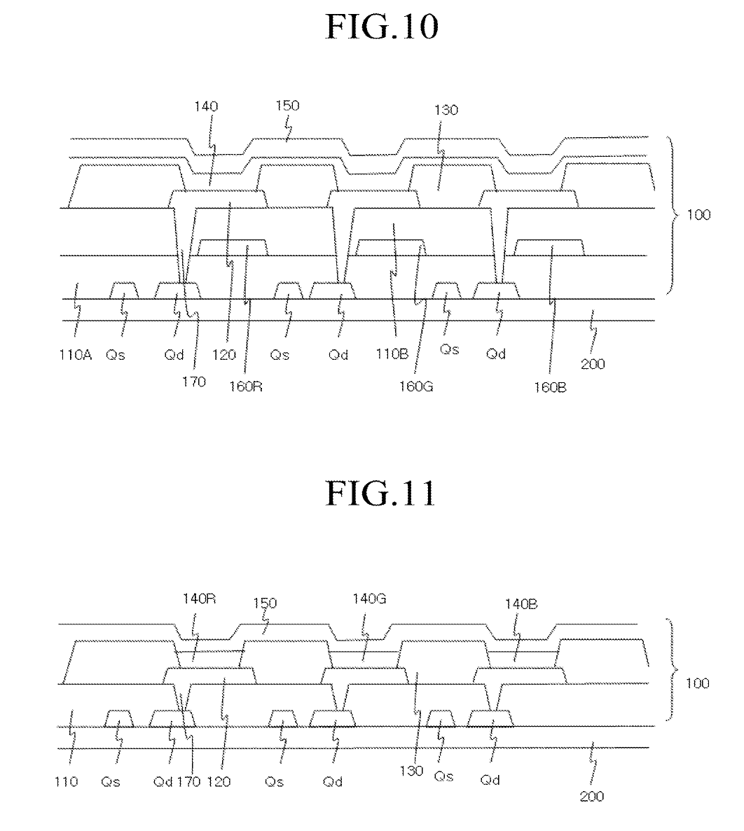

An OLED according to exemplary embodiments of the present invention will be described with reference to FIG. 1, FIG. 2, FIG. 3A, FIG. 3B, FIG. 3C, FIG. 3D, FIG. 3E, FIG. 3F, FIG. 10, and FIG. 11.

FIG. 1 is a plan view of an OLED according to an exemplary embodiment of the present invention. FIG. 2A is a cross-sectional view of the OLED shown in FIG. 1, taken along line I-I′ according to an exemplary embodiment of the present invention. FIG. 2B is a cross-sectional view of the OLED shown in FIG. 1, taken along line I-I′ according to an exemplary embodiment of the present invention. FIG. 3A, FIG. 3B, FIG. 3C, FIG. 3D, FIG. 3E, and FIG. 3F are cross-sectional views showing a method for manufacturing an OLED according to an exemplary embodiment of the present invention. FIG. 10 is a cross-sectional view of a thin film structure according to an exemplary embodiment of the present invention. FIG. 11 is a cross-sectional view of a thin film structure according to an exemplary embodiment of the present invention.

As shown in FIG. 1 and FIG. 2A, an OLED according to an exemplary embodiment includes a thin film structure 100, a display substrate 200, a cover substrate 300, a first sealing member 410, a second sealing member 420, a driving unit 600, a flexible printed circuit board (“FPCB”), 610 and wires (not shown) to transmit signals and power among the driving unit 600, the FPCB 610, and the thin film structure 100.

The display substrate 200 and the cover substrate 300 may be made of transparent material, such as glass or plastic. The display substrate 200 may be larger than the cover substrate 300. Therefore, the cover substrate may be is disposed on the inside of the display substrate 200, and the display substrate 200 includes exposed regions 201A, 201B, 201C and 201D that are not covered by the cover substrate 300.

As shown in FIG. 10, the thin film structure 100 may be disposed on the display substrate 200. The thin film structure 100 may include a switching TFT Qs, a driving TFT Qd, a first insulating layer 110A, a red color filter layer 160R, a green color filter layer 160G, a blue color filter layer 160B, a second insulating layer 110B, a pixel electrode 120, a wall 130, a light emitting layer 140, a common electrode 150, and a contact hole 170. The driving TFT Qd is exposed by the contact hole 170 and is connected to the pixel electrode 120 through the contact hole 170.

Alternatively, as shown in FIG. 11, the thin film structure 100 may include light emitting layers 140R, 140G, and 140B that emit light having different colors, such as red, green, and blue, respectively, instead of the red color filter layer 160R, the green color filter layer 160G, and the blue color filter layer 160B.

Also, as shown in FIG. 11, the thin film structure 100 may include a switching TFT Qs, a driving TFT Qd, an insulating layer 110, a pixel electrode 120, a wall 130, a common electrode 150, and a contact hole 170. The driving TFT Qd is exposed by the contact hole 170 and is connected to the pixel electrode 120 through the contact hole 170.

Referring back to FIG. 1 and FIG. 2A, the driving unit 600 is connected to the FPCB 610, and the FPCB 610 is connected to the thin film structure 100 through the wires (not shown) disposed on the display substrate 200. Therefore, the driving unit 600 and the thin film structure 100 may be connected.

The first sealing member 410 seals the display substrate 200 and the cover substrate 300 and is disposed on an inner surface of the cover substrate 300. The first sealing member 410 may include a light hardening resin or a thermal hardening resin.

For example, the light hardening resin may include a urethane based resin, epoxy based resin, or acryl based resin. The light hardening resin may include a ultraviolet ray (“UV”) hardening resin including 1,6-hexanediol-diacrylate (HDDA) or bis(hydroxyethyl)bisphenol-A dimethacrylate (HEBDM).

For example, the thermal hardening resin may include phenolic resin, silicone resin, or polyimide.

The second sealing member 420 may be disposed on an outer surface of the first sealing member 410 and on the exposed regions 201A, 201B, 201C, and 201D, to enclose an edge portion of the cover substrate 300. The second sealing member 420 may also be disposed on a portion of the FPCB 610.

The second sealing member 420 may include a light hardening resin or a thermal hardening resin and may include the same material as the first sealing member 410.

Also, as shown in FIG. 2B, the OLED may include a passivation layer 500 disposed between the display substrate 200 and the cover substrate 300.

The passivation layer 500 may be a transparent material, and may have a hygroscopic property or a dehumidifying property. The passivation layer 500 may be made by forming a thin sheet on the thin film structure 100 through a lamination process.

The passivation layer 500 may partially or completely fill the space enclosed by the cover substrate 300, the display substrate 200, and the first sealing member 410.

As described above, since the OLED includes the second sealing member 420 disposed on the outside surface of the first sealing member 410, introduction of moisture or oxygen may be more effectively reduced without additional equipment during the manufacturing process.

Therefore, the OLED may be better sealed.

Next, a manufacturing method for forming an OLED according to an exemplary embodiment of the present invention will be described, with reference to FIG. 3A, FIG. 3B, FIG. 3C, FIG. 3D, FIG. 3E, and FIG. 3F.

FIG. 3A, FIG. 3B, FIG. 3C, FIG. 3D, FIG. 3E, and 3F are cross-sectional views showing a method for manufacturing an OLED according to an exemplary embodiment of the present invention.

As shown in FIG. 3A, the thin film structure 100 and the wires (not shown) are formed on the display substrate 200. The thin film structure may not cover the display substrate 200 completely, and the exposed regions 201A, 201B, 201C, and 201D may be exposed on the display substrate 200. A method for forming the thin film structure 100 and the wires may include forming a switching TFT, a driving TFT, and a light emitting layer. A method for forming the switching TFT, the driving TFT, and the light emitting layer may be substantially similar or identical to a method for forming a TFT and an organic light emitting layer in general, and thus detailed descriptions of those methods will be omitted. Also, as shown in FIG. 2B, the passivation layer 500 may be formed on the thin film structure 100, such as through a lamination process.

Next, as shown in FIG. 3B, the first sealing member 410 is coated on the edge portion of the cover substrate 300. As described above, the first sealing member 410 may be formed by using the UV hardening resin or the thermal hardening resin.

Next, as shown in FIG. 3C and FIG. 3D, the display substrate 200 and the cover substrate 300 are attached to each other. Attaching the display substrate 200 and the cover substrate 300 may include one or more steps for accurately aligning the display substrate 200 and the cover substrate 300, and one or more steps for transporting, pressurizing, and attaching the display substrate 200 and the cover substrate 300.

Next, as shown in FIG. 3D, the first sealing member 410 may be cured. A thermal hardening technique or an UV hardening technique may be used if the first sealing member 410 is formed by using the thermal hardening resin or the UV hardening resin, respectively. That is, the first sealing member 410 is cured by irradiating the first sealing member 410 with UV light or heating the first sealing member 410 while the display substrate 200 and the cover substrate 300 are attached together. A mask 700 may be used to prevent the UV light or the heat from damaging the thin film structure 100, and may be arranged on the cover substrate 300 corresponding to the thin film structure 100.

Next, as shown in FIG. 3E, an assembling step to connect the driving unit 600 and the FPCB 610 to the display substrate 200 is performed. The driving unit 600 is connected to the display substrate 200 through FPCB 610 and the wires (not shown).

Next, as shown in FIG. 3F, the second sealing member 420 may be formed by coating and curing the UV hardening resin or the thermal hardening resin on the outside surface of the first sealing member 410 and the cover substrate 300. Curing the UV hardening resin or the thermal hardening resin may be performed by irradiating UV light or heat, respectively. The second sealing member 420 may cover the exposed regions 201A, 201B, 201C, and 201D that are not covered by the cover substrate 300.

While irradiating UV light or heat to cure the second sealing member 420, the mask 700 used to prevent the UV light or the heat from damaging the thin film structure 100 may be arranged on the cover substrate 300 corresponding to the thin film structure 100.

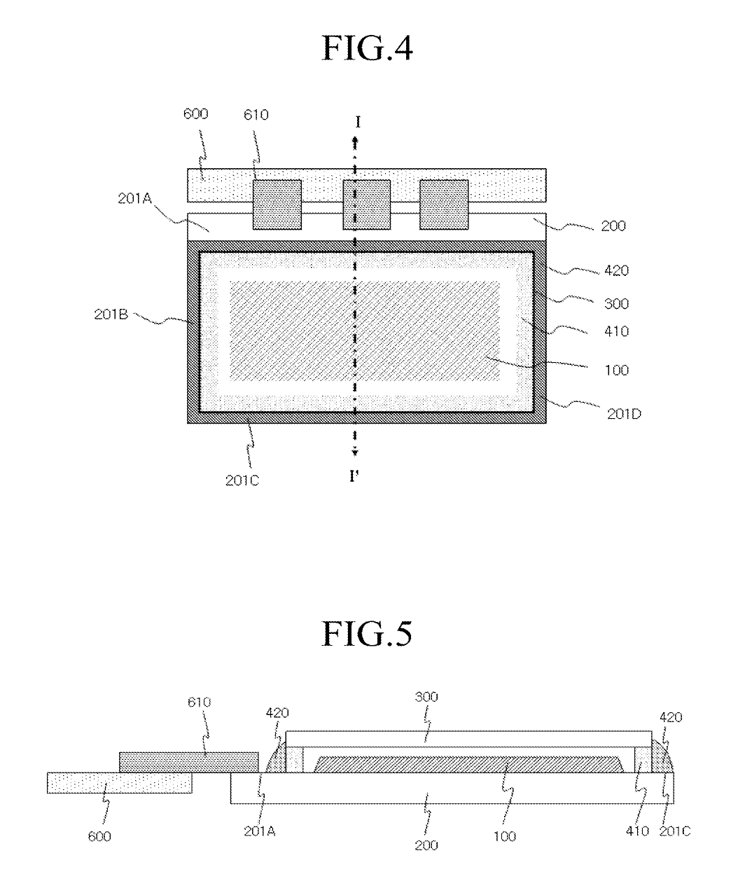

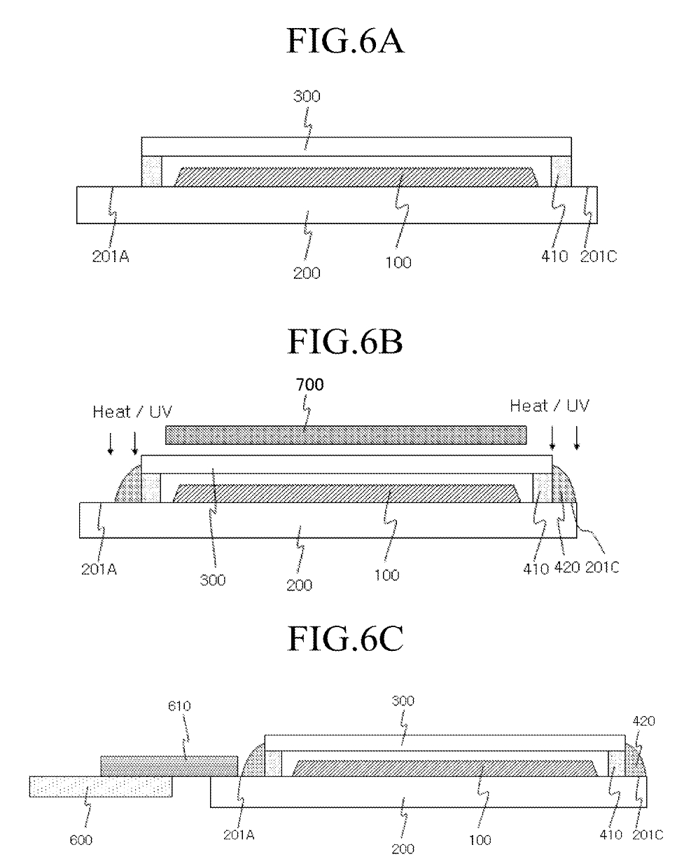

Next, an OLED according to exemplary embodiments of the present invention will be described with reference to FIG. 4, FIG. 5, FIG. 6A, FIG. 6B, and FIG. 6C.

FIG. 4 is a plan view of an OLED according to an exemplary embodiment of the present invention. FIG. 5 is a cross-sectional view of the OLED taken along line I-I′ according to the exemplary embodiment of the present invention. FIG. 6A, FIG. 6B, and FIG. 6C are cross-sectional views showing a method for manufacturing an OLED according to an exemplary embodiment of the present invention.

As shown in FIG. 4 and FIG. 5, an OLED according to an exemplary embodiment includes a thin film structure 100, a display substrate 200, a cover substrate 300, a first sealing member 410, a second sealing member 420, a driving unit 600, a FPCB 610, and wires (not shown). Although not shown, a passivation layer may be formed on the thin film structure 100, and may partially or completely fill the space enclosed by the cover substrate 300, the display substrate 200, and the first sealing member 410.

Unlike as shown in FIG. 1, the second sealing member 420 does not contact the FPCB 610 in the exemplary embodiment shown in FIG. 4 and FIG. 5. Therefore, as shown in FIG. 5, a portion of exposed region 201A remains exposed even after the second sealing member 420 has been arranged on the display substrate 200.

Next, the manufacturing method for forming an OLED according to an exemplary embodiment of the present invention will be described, with reference to FIG. 6A, FIG. 6B, and FIG. 6C.

As shown in FIG. 6A, the display substrate 200 including the thin film structure 100 and the cover substrate 300 including the first sealing member 410 are attached to each other and the first sealing member 410 is cured, similar to FIG. 3A, FIG. 3B, FIG. 3C, and FIG. 3D.

Next, as shown in FIG. 6B, the second sealing member 420 may be formed by coating and curing the UV hardening resin or the thermal hardening resin on the outside surface of the first sealing member 410 and the cover substrate 300. Curing the UV hardening resin or the thermal hardening resin may be performed by irradiating UV light or heat, respectively.

Next, as shown in FIG. 6C, an assembling step of connecting the driving unit 600 and the FPCB 610 to the display substrate 200 is performed. The driving unit 600 is connected to the display substrate 200 through the FPCB 610 and the wires (not shown).

Therefore, the manufacturing method for forming an OLED according to exemplary embodiments of the present invention with reference to FIG. 4, FIG. 5, FIG. 6A, FIG. 6B, and FIG. 6C may form the second sealing member 420 before the assembling step of connecting the driving unit 600 to the display substrate 200 through the FPCB 610 and the wires. Also, in the present exemplary embodiment, the second sealing member 410 does not contact FPCB 610.

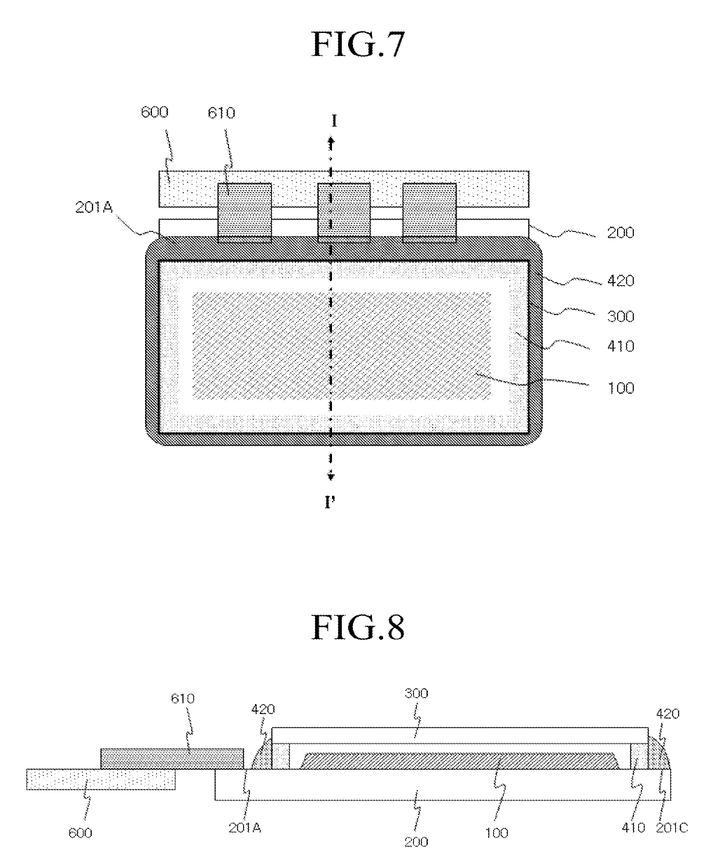

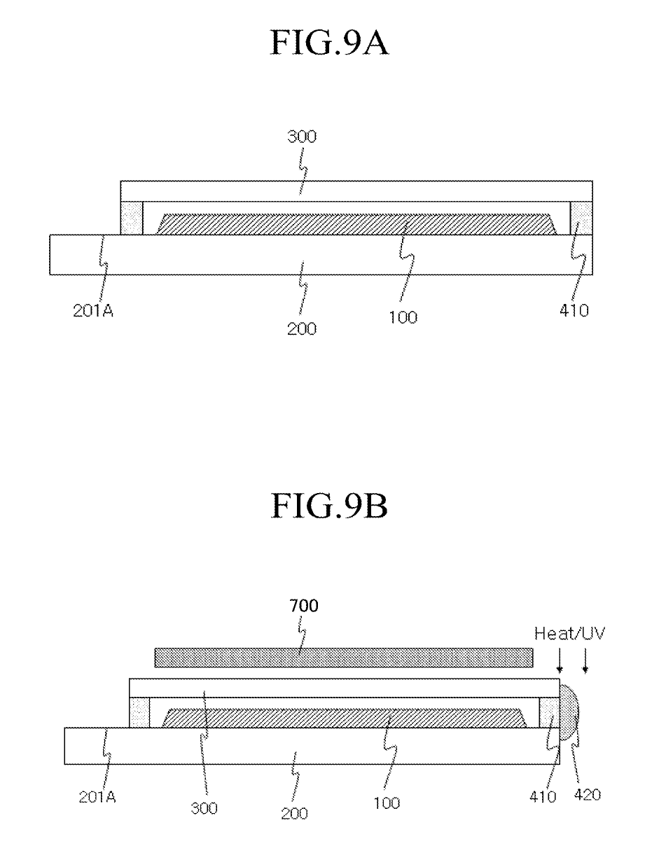

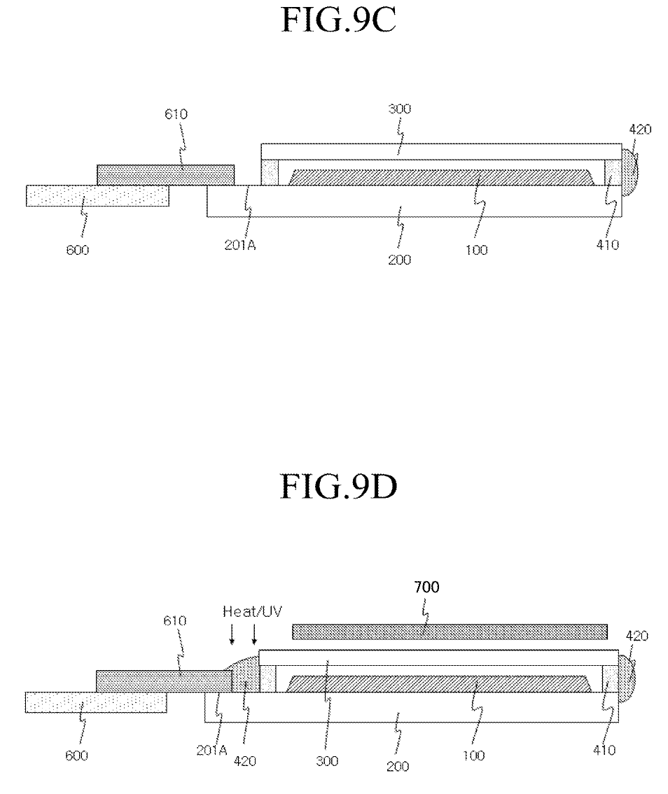

Next, an OLED according to exemplary embodiments of the present invention will be described with reference to FIG. 7, FIG. 8, FIG. 9A, FIG. 9B, and FIG. 9C.

FIG. 7 is a plan view of an OLED according to an exemplary embodiment of the present invention. FIG. 8 is a cross-sectional view of the OLED taken along line I-I′ according to an embodiment of the present invention. FIG. 9A, FIG. 9B, FIG. 9C, and FIG. 9D are cross-sectional views showing a method for manufacturing an OLED according to an exemplary embodiment of the present invention.

As shown in FIG. 7 and FIG. 8, an OLED according to this exemplary embodiment includes a thin film structure 100, a display substrate 200, a cover substrate 300, a first sealing member 410, a second sealing member 420, a driving unit 600, a FPCB 610, and wires (not shown). Although not shown, a passivation layer may be formed on the thin film structure 100, and may partially or completely fill the space enclosed by the cover substrate 300, the display substrate 200, and the first sealing member 410.

Unlike as shown in FIG. 1, the size of the display substrate 200, except for the exposed part 201A, is substantially equal to the size of the cover substrate 300 in this exemplary embodiment. Thus, the display substrate 200 includes only exposed region 201A, on which FPCB 610 is disposed, and not exposed regions 201B, 201C, and 201D.

Also, as shown in FIG. 8, the second sealing member 420 may be disposed on an outer surface of the cover substrate 300 and three edges of the display substrate 200 to enclose the cover substrate 300 and the display substrate 200. The second sealing member 420 may be disposed on the exposed part 201A, and may contact FPCB 610.

Next, the method for forming an OLED according to an exemplary embodiment will be described, with reference to FIG. 9A, FIG. 9B, FIG. 9C, and FIG. 9D.

As shown in FIG. 9A, the display substrate 200 including the thin film structure 100 and the cover substrate 300 including the first sealing member 410 are attached to each other, and the first sealing member 410 is cured, similar to FIG. 3A, FIG. 3B, FIG. 3C, and FIG. 3D.

Next, as shown in FIG. 9B, the second sealing member 420 is formed by coating and curing the UV hardening resin or the thermal hardening resin on the outer surface of the cover substrate 300 and three edges of the display substrate 200 to enclose the display substrate 200 and the cover substrate 300. The curing of the UV hardening resin or the thermal hardening resin may be performed by irradiating UV light or heat, respectively.

Next, as shown in FIG. 9C, an assembling step connecting the driving unit 600 and the FPCB 610 to the display substrate 200 is performed. The driving unit 600 is connected to the display substrate 200 through the FPCB 610 and the wires (not shown).

Next, as shown in FIG. 9D, the second sealing member 420 is formed by coating and curing the UV hardening resin or the thermal hardening resin on the exposed part 201A. The curing of the UV hardening resin or the thermal hardening resin may be performed by irradiating UV light or heat, respectively.

Although not shown, in a method for manufacturing an OLED according to an alternate exemplary embodiment, the second sealing member 420 may not contact the FPCB 610. Therefore, the assembling step shown in FIG. 9C and the coating and curing step shown in FIG. 9D may be performed in a different order. In this alternate exemplary embodiment, a portion of exposed region 201A remains exposed even after the second sealing member 420 has been arranged on the display substrate 200. After the second sealing member 420 has been coated on a portion of exposed region 201A and cured, the driving unit 600 may be connected to the display substrate 200 through FPCB 610 and the wires.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An organic light emitting device, comprising:
a first substrate;
a thin film structure disposed on the first substrate;
a second substrate comprising an inner surface and an outer surface;
a first sealing member disposed between the first substrate and the second substrate, the first sealing member comprising an inner surface and an outer surface; and
a second sealing member disposed on the outer surface of the second substrate.

2. The organic light emitting device of claim 1,
wherein the first sealing member is disposed on the inner surface of the second substrate.

3. The organic light emitting device of claim 2,
wherein the second sealing member is disposed on the outer surface of the first sealing member.

4. The organic light emitting device of claim 3,
wherein the first substrate and the second substrate extend in a first direction and a second direction perpendicular to the first direction, and the first substrate extends in both the first direction and the second direction for a greater distance than the second substrate.

5. The organic light emitting device of claim 4,
wherein the first substrate comprises at least one exposed region not covered by the second substrate.

6. The organic light emitting device of claim 5,
wherein the second sealing member is disposed on the at least one exposed region.

7. The organic light emitting device of claim 6,
wherein the second sealing member encloses the second substrate.

8. The organic light emitting device of claim 6, further comprising:
a driving unit; and
a flexible printed circuit board connected to the thin film structure and the driving unit.

9. The organic light emitting device of claim 8,
wherein the flexible printed circuit board is disposed on the at least one exposed region.

10. The organic light emitting device of claim 9,
wherein the first substrate is covered by the second substrate, except for the at least one exposed region of the first substrate on which the flexible printed circuit board is disposed.

11. The organic light emitting device of claim 10,
wherein the second sealing member is disposed on the at least one exposed region of the first substrate except for the exposed region on which the flexible printed circuit board is disposed.

12. The organic light emitting device of claim 1,
wherein the thin film structure comprises a switching thin film transistor, a driving thin film transistor, a pixel electrode, a light emitting layer, and a common electrode.

13. A method for manufacturing an organic light emitting device, comprising:
forming a thin film structure on a first substrate;
arranging a second substrate to face the first substrate, the second substrate comprising an inner surface and an outer surface;
forming a first sealing member between the first substrate and the second substrate, the first sealing member comprising an inner surface and an outer surface; and
forming a second sealing member on the outer surface of the second substrate.

14. The method of claim 13,
wherein forming the first sealing member comprises:
coating a light hardening resin or a thermal hardening resin on an edge portion of the second substrate;
attaching the first substrate and the second substrate to each other; and
curing the light hardening resin or the thermal hardening resin.

15. The method of claim 13,
wherein forming the second sealing member comprises:
coating a light hardening resin or a thermal hardening resin on the outer surface of the first sealing member and the outer surface of the second substrate; and
curing the light hardening resin or the thermal hardening resin.

16. The method of claim 15,
wherein arranging the second substrate comprises arranging the second substrate, which is smaller than the first substrate.

17. The method of claim 16,
wherein at least one edge of the first substrate comprises an exposed portion not covered by the second substrate, and the second sealing member is formed on the exposed portion.

18. The method of claim 13, further comprising:
arranging a driving unit; and
forming a flexible printed circuit board to connect the thin film structure and the driving unit.

19. The method of claim 18,
wherein a portion of the flexible printed circuit board contacts a portion of the second sealing member.

20. The method of claim 13,
wherein forming the thin film structure comprises:
forming a switching thin film transistor and a driving thin film transistor;
forming an insulating layer on the switching thin film transistor and the driving thin film transistor;
forming a contact hole in the insulating layer to expose the driving thin film transistor;
forming a pixel electrode connected to the driving thin film transistor through the contact hole;
forming a light emitting layer on the pixel electrode; and
forming a common electrode on the light emitting layer.
